(19) United States
(12) Patent Application Publication
(10) Pub. No.: US 2024/0322376 A1
(43) Pub. Date: Sep. 26, 2024

(54) BASE TREATED BATTERY SEPARATORS EXHIBITING HYDROFLUORIC ACID SCAVENGING CHARACTERISTICS

(71) Applicant: Soteria Battery Innovation Group, Inc., Greenville, SC (US)

(72) Inventors: Brian G. Morin, Greenville, SC (US); Carl C. Hu, Taylors, SC (US); Drew J. Pereira, Greenville, SC (US)

(21) Appl. No.: 17/709,409

(22) Filed: Mar. 31, 2022

Related U.S. Application Data
(60) Provisional application No. 63/170,435, filed on Apr. 2, 2021.

(51) Int. Cl. H01M 50/489; H01M 10/0525; H01M 50/403

(52) U.S. Cl. CPC H01M 50/489; H01M 10/0525; H01M 50/403

(57) ABSTRACT

The present disclosure relates to separators for lithium-ion batteries that exhibit hydrofluoric acid scavenging characteristics subsequent to treatment with certain types and amounts of caustic formulations. Such a basic treatment creates surface complexes with counterions that react with HF to capture dissociated fluorine ions thereby reducing the amount of potentially damaging acid within the subject battery during utilization thereof. Such a surface counterion-fluorine complex on the separator exhibits low propensity to dissociate thereafter, thus reducing the presence of oxidative/acidic fluorine ions and prolonging battery cell life through increased charging levels.

### CROSS-REFERENCE TO RELATED APPLICATIONS

This application claims priority to pending U.S. Provisional Patent Application No. 63/170,435, filed on Apr. 2, 2021, the entirety of which is herein incorporated by reference.

### FIELD OF THE DISCLOSURE

The present disclosure relates to separators for lithium-ion batteries that exhibit hydrofluoric acid scavenging characteristics subsequent to treatment with certain types and amounts of caustic formulations. Such a basic treatment creates surface complexes with counterions that react with HF to capture dissociated fluorine ions thereby reducing the amount of potentially damaging acid within the subject battery during utilization thereof. Such a surface counterion-fluorine complex on the separator exhibits low propensity to dissociate thereafter, thus reducing the presence of oxidative/acidic fluorine ions and prolonging battery cell life through increased charging levels.

### BACKGROUND OF THE PRIOR ART

A major impediment to cost effective deployment of advanced lithium-ion batteries (LIB) is the problem of capacity fading/reduced cycle lifetime. The electrolytes of conventional lithium-ion batteries typically consist of a mixture of linear and cyclic organic carbonates and lithium hexafluorophosphate (LiPF₆). Even the purest grades of battery electrolytes typically contain about 25 ppm water, which without being limited by mechanism may be due to the hydroscopic properties of LiPF₆. The presence of water and moisture causes decomposition and subsequent formation of HF, which attacks and dissolves transition metals in a number of different cathode compositions. The presence of hydrofluoric acid (HF) in the liquid electrolyte has been identified as a major cause of this decomposition and reduced battery life. The dissolved metal ions migrate to and plate on the lithium/graphite anode, causing the lithium/graphite anode to fail. HF can also attack and leach out inorganic species (for example, LiF) deposited on cathode surface. If this takes place, the cathode surface, onto which LiF was once deposited, is now exposed to the electrolyte solution, and additional electrolyte decomposition occurs on the newly exposed surface. Several approaches have been used to improve the structural stability of cathodes in the presence of HF, including protective coatings, and utilization of basic additives in the electrolyte that chemically scavenge HF. Protective/reactive coatings have also been deposited on the separator. One drawback to all of these approaches is that they add mass and volume to the LIB without contributing to its capacity and/or power density. Further, battery decomposition is not readily detectable before the failure point of the battery. The ability to scavenge fluorine ions reliably within a subject lithium-ion battery cell (liquid electrolyte type) would thus be of significant benefit in this area.

### ADVANTAGES AND SUMMARY OF THE DISCLOSURE

A distinct advantage of this disclosure is the ability to reduce harmful free HF within a battery through the provision of a suitably treated separator component. Another distinct advantage is the facilitated process of caustic treatment of a pre-formed separator introduced within a battery device for such HF reductions. Thus, another distinct advantage of the disclosure is the ability to impart improvements to typical rechargeable batteries with such treated separators.

Accordingly, encompassed within this disclosure is a battery separator for a lithium-ion battery cell, said battery separator exhibiting counterions on the surface thereof, wherein said counterions are selected from the group consisting of ions contributed by bases having pK_{b} levels of at most 6.0, preferably at most 4.0, and wherein said battery separator exhibits hydrofluoric acid scavenging properties. Additionally, this disclosure encompasses the battery separator noted above, wherein said counterions are selected from sodium ion, magnesium ion, potassium ion, barium ion, and calcium ion. Batteries (and other energy storage devices) comprising the battery separator note above are also encompassed herein.

As alluded to above, Hydrogen fluoride, HF, and the aqueous form of hydrogen fluoride (hydrofluoric acid) are highly corrosive compounds. HF corrosion is a problem particularly associated with batteries containing lithium, lithium hexafluorophosphate, or other lithium salts containing fluorine. This application provides an HF-scavenging separator or separators that exhibit the presence of counterions of bases exhibiting a pK_{b} of at most 6.0 (preferably, as noted above, at most 4.0). The term “HF-scavenging separator” is intended to relate to a separator that scavenges, binds, traps, ties, reacts, secures, or confines HF. The HF in the HF-scavenging separator is less able to damage components than free HF. In some embodiments, an HF-scavenging separator increases battery life. Such separators may also, as noted above, exhibit hygroscopicity to allow for moisture absorption within the target battery cell, as well, upon utilization thereof.

A lithium-ion battery exhibiting increased HF-scavenging (and possible moisture-absorbing) properties comprising a pre-formed and subsequently caustic-treated battery separator is provided. A battery as provided may exhibit decreased HF damage. The term “decreased HF damage” is intended to relate to reducing, lowering, and/or improving HF related damage to one or more battery component(s), reduced or lowered HF related damage during a period of time, or an extended period with medium to high capacity as compared to a battery without such a specifically caustic-treated pre-formed separator. A lithium-ion battery with increased HF-scavenging properties may comprise a component lined with or by such a pre-formed caustic-treated separator. The lined component may be selected from the group of components comprising an anode, a cathode, an encapsulating material (maybe even a current collector), and a different type of electrolyte ion conducting material. The term “encapsulating material” is intended to relate to any structure or device surrounding an anode, cathode, and electrolyte, such as, but not limited to, a wall, lid, top, floor, can, or canister. The base-treated separator article may thus be introduced within a lithium construction manufacturing procedure, placing such a treated separator between an anode and cathode, including at least one current collector (with connections to allow for electrical transfer from the battery externally), placing the resultant structure within a cell enclosure, introducing liquid electrolytes therein, and sealing the same. The resultant lithium-ion battery may then be charged and recharged and utilized with external mechanical/electrical devices to provide power thereto.

Such HF scavenging capabilities of pre-formed separator articles treated with low pK_{b} formulations, and the presence of certain counterions thereon the surface, may provide highly effective results for reducing internal battery cell degradation and damage during use with concomitant improved cell charging life and cycles thereof. This disclosure thus provides, as one potential embodiment, a hydrogen fluoride (HF)-scavenging separator article (nonwoven or film), and potentially more particularly, a moisture-absorbing separator wherein the membrane is capable of also absorbing moisture within a target battery cell in addition to HF. Such a potential separator may be formed or manufactured initially and subsequently subjected to a basic treatment to cause complex formation of surface-based hydroxyls with counterions therefrom. In various aspects, such a base is selected from the group of bases exhibiting at most a pK_{b} of 6.0 (preferably at most 4.0), including, without limitation, sodium hydroxide, potassium hydroxide, lithium hydroxide, barium hydroxide, calcium hydroxide, and magnesium hydroxide. Such a moisture-absorbing membrane may further comprise at least one additive, such as, without limitation, Al₂O₃. Such a separator, to provide sufficient physical properties within a target battery (or other like energy storage device) preferably exhibits a tensile strength of at least 35 MPa and an air permeability greater than 65 Gurley s. Additionally, such a potential embodiment for a separator exhibits high ionic conductivity and an average pore size less than or equal to d_{dendr}.

This disclosure further provides a battery (or other type of energy storage device, such as a capacitor, for example) with increased moisture scavenging properties wherein the battery comprises a moisture-absorbing separator having surface complexed counterions present thereon subsequent to caustic treatment. In this manner, the disclosed battery exhibits decreased HF damage propensity in relation to such a treated separator. Such a separator (or separators) is introduced between an anode and a cathode and adjacent at least one current collector within such a target battery (or energy storage device). Such a battery embodiments exhibits, as well, at least 90% capacity after 250 cycles.

The disclosure thus provides methods of decreasing moisture within a battery comprising incorporating a moisture-absorbing membrane of the application in the battery with the potential for simultaneous methods of decreasing free HF therein.

Unless defined otherwise, all technical and scientific terms used herein have the meaning commonly understood by a person skilled in the art to which this invention belongs.

“A”, “an”, and “the”, as used herein, can include plural referents unless expressly and unequivocally limited to one referent.

The term “separator” is intended to include a film, nonwoven structure, sheet, laminate, tissue, or planar flexible solid. Separator characteristics include, but are not limited to, thickness, strength, pliability, tensile strength, porosity, and other characteristics. It is recognized that different separators or different types thereof may exhibit different or similar characteristics.

The term “ion-conducting separator” is intended to relate to a separator between two electrodes, being an anode and a cathode, or being a positive electrode and a negative electrode. An ion-conducting separator allows ion flow between two regions whilst dividing, separating, or partitioning two regions.

The term “moisture-absorbing separator” is intended to include a separator capable of absorbing, taking in, retaining, soaking, internalizing, or trapping a liquid. Liquids of interest include, but are not limited to, organic solutions, aqueous solutions, electrolyte solutions, hydrofluoric acid, HF, and carbonate-based electrolyte solutions. Preferably, such a caustic treated HF-scavenging (and moisture-absorbing due to hygroscopic groups potentially present thereon the surface) may generally retain its original dimensions upon absorbing moisture or may generally change dimensions minimally to best ensure complete coverage of the separation interface between electrodes.

The type of separator or separators (more than one may potentially be utilized within a battery) that is treated with the suitable low pK_{b} base(s) described herein may include, without limitation, i) films, such as, without limitation, polyolefins such as polypropylene, polyethylene, bilayer polypropylene and polyethylene, and combinations of polyolefinic films thereof, such polyolefins with ceramic coatings (which may contribute an increased capability of complexing with base counterions itself), ii) ceramic separators alone or with nonwoven reinforcements, iii) nonwoven fabric structures with ceramic coatings, iv) nonwoven fabric structures having microfibers, nanofibers, combinations thereof, uniformly sized microfibers, uniformly sized nanofibers, enmeshed microfibers and nanofibers, single-layer nonwovens of such types, bi- or multi-layer nonwovens of individual microfiber layers, individual nanofiber layers, individual layers of enmeshed and/or combined microfibers and nanofibers, and any combinations thereof, and v) polymeric structures with independent surface groups and moieties that may complex with base counterions, including, without limitations, polyvinyl alcohols films, polycarbonate films (both having free hydroxyl groups present on the surfaces thereof, as non-limiting examples), combinations thereof, and the like. The ability to accord such a basic treatment with fluorine-capturing counterions present on the separator surface(s) provides the desired effect and thus any type of separator treated in such a manner and/or having free complexing groups thereon and free for such complexation potential (hydroxyl groups, again, as a non-limiting example) may be employed and implemented in this manner. The accepted and well understood purpose of separators within lithium-ion battery structures lends itself to this overall capability since electrolytes flow through such separators within such batteries and the generation of and thus presence of HF within the subject cell has proven likely and elusively remedied. As noted above, it is believed that hydrogen fluoride (and thus, ultimately hydrofluoric acid) is a resultant reaction product of electrolytes and moisture within a lithium-ion battery. Such an acidic species is believed to contribute to degradation within the subject battery cell over time as such an oxidative ionic compound (free fluorine ions, in essence) may bind internally with delicate metallic parts thereby reducing the effectiveness thereof and, again, leading ultimately to cell shutdown. Additionally, the process may be slow and steady over time in this respect, creating degradative results in relation to battery charging (particularly with such rechargeable lithium-ion types) leading to drastically reduced charge cycles requiring a user to seek recharging more often. Ultimately, the charge cycles retain lower charge levels, leading to battery cell ineffectiveness and replacement. As well, such cell degradation may also cause electrolytes to form undesirable and potentially dangerous dendrites and like structures within the cell that could lead to short circuiting, at least. The ability to reduce the chances of such destructive possible outcomes may thus be of significance for such lithium-ion battery technologies.

Such base-treated separators may be, as alluded to above, of any type that provides the needed electrolyte transfer within the subject cell between electrodes (through the presence of pores, for instance, of suitable size for such a purpose, at least). Such separators may be formed from different materials including, for, in one non-limiting example, nonwoven fabric structures made from various types of fibers (as alluded to above). Such fibers may be of any diameter, from structures having uniformly sized fibers and the same fiber constituent materials, to variously sized fibers made from different materials. The materials thus may be selected from synthetic and natural fibers, microns in diameter, nanometers in diameter, combinations of microfibers and nanofibers, enmeshed microfibers and nanofibers, and the like. Such fibers in terms of materials, may be polymeric in nature, including, without limitation, cellulose, polyacrylonitriles, polyolefins, polyolefin copolymers, polyamides, polyvinyl alcohol, polyethylene terephthalate, polybutylene terephthalate, polysulfone, polyvinyl fluoride, polyvinylidene fluoride, polyvinylidene fluoride-hexafluoropropylene, polymethyl pentene, polyphenylene sulfide, polyacetyl, polyurethane, aromatic polyamide, semi-aromatic polyamide, polypropylene terephthalate, polymethyl methacrylate, polystyrene, synthetic cellulosic polymers, and blends, mixtures and copolymers thereof. Such fibers may be provided as microfibers and nanofibers to form a single-layer structure (nonwoven) with the requisite aramid fibers present therein as well. Such structures may be formed according to the materials and methods disclosed within U.S. Pat. Nos. 8,936,878, 9,637,861, and 9,666,848, as examples.

Such separators may also be film structures, as noted above, as well. Such films include those with pore structures therein for effective electrolyte transfer (again, as noted above). Examples include, without limitation, CELGARD and POLYPORE separator products (polyolefin types, such as polypropylene films with electrolyte transfer capabilities, again, as noted above). Other possible separator articles provided as a manufactured structure for subsequent base-treatment include, as noted previously, without limitation, ceramic separators, nonwoven types with ceramic coatings, polyolefin film types with ceramic coatings, polycarbonate films, polyvinyl alcohol films, and combinations thereof.

Subsequent to providing such separator structures for eventual implementation and introduction within a target lithium-ion battery cell, the separator is treated with base to effectuate the presence of counterion (such as sodium ion, magnesium ion, calcium ion, potassium ion, barium ion, and, to a lesser extent, though possible if lithium hydroxide is utilized as the caustic base, lithium-ion) complexed on the separator surface. The ability to form such a complex may be increased with the presence of certain materials having free hydroxyl (or like) groups as the separator constituent(s). A pre-base application treatment may also be undertaken, at least hypothetically, to allow for such complexation to occur, as well, if desired and/or needed. Such a caustic treatment may thus include, without limitation, any application step such as immersion, spraying, spray-coating, brush (or the like) coating, and any like procedure(s). Such a basic formulation may be of any suitable molarity to ensure complexation on the target separator surface with a level thereof that does not itself prove deleterious in utilization to a potentially thin and delicate separator article. Thus, the concentration of base within such a treatment formulation may be from about 0.1 to 10 molarity (within an aqueous solution, or alternatively, within an aprotic solvent, as a possibility, including, without limitation DMSO, for instance). More focused in terms of molarity is a possible level between 0.2 to 5, a most preferred may be from 05 to 5. Again, such a level allows for sufficient loading of counterion upon application to the target separator surface; too low a molarity would fail to produce the necessary level for fluorine ion scavenging (capture); too high could cause undesirable degradation of the target separator article itself. Thus, the introduced base treatment should effectuate such desired complex levels without actually damaging, shrinking, etc., the subject separator. The method may thus further include a drying step to remove any excess moisture (due to the aqueous nature of the caustic formulation) from the separator surface prior to introduction thereafter within a target lithium-ion battery cell. Such a drying step may include oven-drying, vacuum drying, or air-drying, or even the potential for forced air drying, particularly at a temperature level that would be sufficiently low to ensure dimensional stability of the treated separator article prior to such battery cell implementation.

Bases (as alluded to above) for use in the post-separator formation/manufacture caustic treatment include, but are not limited to, sodium hydroxide, potassium hydroxide (KOH), lithium hydroxide, calcium hydroxide, barium hydroxide, and magnesium hydroxide (all exhibiting a pK_{b} of at most 6.0, more particularly at most 4.0). In some methods, the preferred base is sodium hydroxide (NaOH) or KOH. In other methods, the preferred base is calcium or barium hydroxide. The ability to generate surface counterion complexes on the subject separator with such a subsequent caustic treatment procedure (after manufacture and/or formation, as noted herein) provides the apparent HF-scavenging capabilities (as well as possible hygroscopic characteristics) for such a treated separator. As such, a separator exhibiting a counterion of any of a pK_{b} at most 6.0, preferably at most 4.0, base on its surface would be considered encompassed within this disclosure.

The counterion complexing on the target separator surface(s) may be transferred in such a manner in an amount sufficient to effectuate such desired fluorine scavenging levels (and potentially permitting moisture absorption as well). Such counterion levels may be measured utilized X-ray Photoelectric scanning procedures (XPS) subsequent to the complexation and drying steps noted above. A measure of percentage counterion based on overall weight of the separator of between 0.01 and 1 (preferably from 0.1 and 1; more preferably from about 0.1 to about 0.75) may be targeted for such a purpose.

### BRIEF DESCRIPTION OF THE DRAWINGS

FIG. 1 is a graphical representation of the pH of tested separators (treated and untreated) in relation to surface area.

FIG. 2 is a graphical representation of the concentration of HF on tested separators in relation to surface area.

FIG. 3 is a graphical representation of the concentration difference of HF on tested separators in relation to surface area.

FIG. 4 is a graphical representation of the moles of scavenged HF on tested separators in relation to surface area.

FIG. 5 is a graphical representation of the grams of scavenged HF on tested separators in relation to grams of separator.

### DETAILED DESCRIPTION OF THE DRAWINGS AND PREFERRED EMBODIMENTS

The following descriptions and examples are merely representations of potential embodiments of the present disclosure. The scope of such a disclosure and the breadth thereof in terms of claims following below would be well understood by the ordinarily skilled artisan within this area.

As presented above, the discovery that caustic-treated battery separators for rechargeable systems (lithium-ion, sodium-ion, and the like) provide hydrofluoric acid (or hydrofluoride) scavenging accords improvements in this area that allow for better safety and performance overall. In this respect, separators were provided and treated with certain caustic solutions and then individually tested for a number of properties related to such HF concentrations and pH levels.

To that end, undertaken was a study to evaluate the HF scavenging performance for one exemplified battery separator type (Dreamweaver Gold 20) as well as the performance after base-treatment of the same separator.

### Separator Preparation

Varied amounts of dried separator were exposed to a set amount of dummy electrolyte (electrolyte components without the LiPF₆ salt which would react in a cyclic manner). The dummy electrolyte contained an initial HF content to test scavenging thereof solely in relation to caustic treatment. Some of the separator samples were pre-dosed with an excess base solution and appropriate drainage, then thoroughly dried to remove residual base solution and others were left untreated. For comparisons, separators (as noted below) were treated with 3N sodium hydroxide and 3N barium hydroxide, with other samples untreated in relation to basic solutions. The resulting solutions were measured for pH levels which allowed for a study of separator amount and base-treatments on the effect of separator HF scavenging ability.

A4 hand sheets of Dreamweaver Gold 20 Separator were thus utilized with discs were removed from such hand sheets utilizing a 13 mm diameter punch-die or a Silhouette Cameo 4 cutter. For the Cameo 4, A4 sheets were taped to a low-tack backing and fed into the apparatus. A manual blade was used with its depth set to 7. Program settings for the Cameo 4 included a depth setting of 2, force setting of 15, and 10 passes. Programmed into the Cameo 4 software was an array of 13 mm discs. After cutting/punching, the discs were placed into small 20 mL PTFE vials. Such PTFE vials were used to avoid etching in traditional glass vials in relation to the HF present. The base-treated and untreated separators were thus produced in this manner with the vials introduced with the sodium hydroxide and barium hydroxide (3N solutions) as noted above.

Such vials with separator were then placed into a vacuum oven for at least 48 hours to ensure a thorough drying at a temperature of 125° C.

A “dummy” electrolyte was produced and utilized in this experimental analysis in order to gain a better understanding of the HF scavenging capability of the treated separator components. In a real electrolyte, the main salt, LiPF₆, would cause a cyclic reaction to occur, convoluting the results. Instead, the main components of a conventional electrolyte were used, namely Ethyl Methyl Carbonate (EMC) and Ethylene Carbonate (EC) (both procured from Sigma Aldrich). To make the dummy electrolyte, EC was heated to reach its melting point, then added into a glass flask. EMC was added to the flask so that the ratio of the two chemicals would be 1:1 by volume and mixed well. From the master batch of dummy electrolyte, portions were divided and placed into smaller flasks. These portions were “dosed” with HF solution to the desired initial HF concentration for each experiment and mixed well.

Sample vials containing separator were then removed from oven and immediately dosed with dummy electrolyte and sealed to mitigate the contamination of samples from ambient humidity within the laboratory space. For all samples, 7 mL of dummy electrolyte was used in order to thoroughly wet the separator and have enough extra solution to sample from while measuring pH at the end of test. Vials were sealed with a PTFE cap. The vials would remain sealed and stored in a Bel-Art Dry Keeper Desiccant Cabinet for the predetermined exposure time.

At the end of the exposure time, the samples were removed one at a time for analysis. To avoid damage of the probe and ensure measurement within a reasonable pH range, samples were dosed with 10 mL water and mixed well. In this study, a Mettler Toledo SevenCompact S220 pH/Ion meter was used. To conduct analysis, the mixed sample would be left uncapped and the pre-calibrated probe would be dipped into the sample.

### Results and Discussion

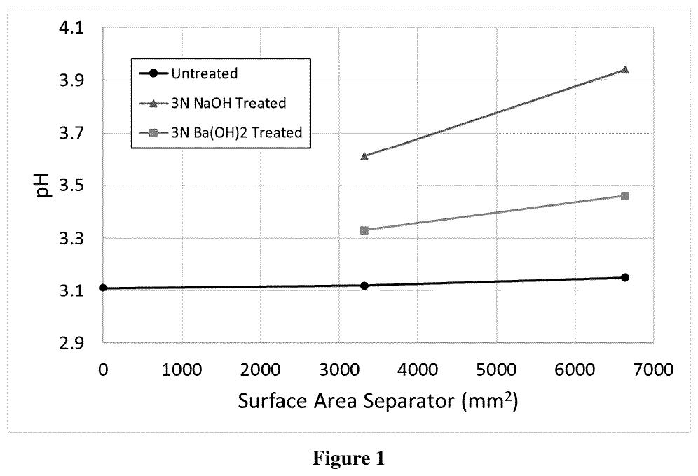

An initial analysis pertained to measuring pH levels of the sample separators. The raw data is shown in the graphical representation of FIG. 1 with the untreated separator exhibiting a trend of increasing pH but at much lower levels in comparison with the hydroxide-treated separators. Thus, there is a clear trend of increasing pH with increasing separator surface area. The pH can be transformed into concentration of hydrogen ions, [H⁺], using the following equation:

$$[ {H}^{+} ] = {10}^{- pH}$$

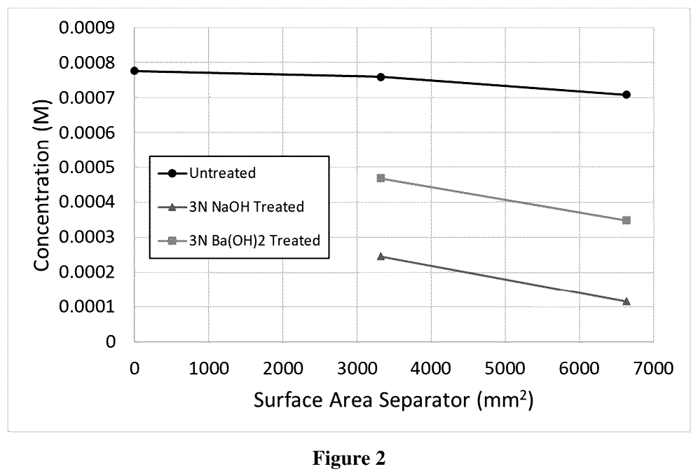

FIG. 2 thus shows a similar upward graphical trend for treated separators in relation to concentration of scavenged [H⁺]. The equation of

$${[ {H}^{+} ]}_{blank sample} - {[ {H}^{+} ]}_{sample} = {[ {H}^{+} ]}_{scavenged}$$

basically shows such a result in relation to the measured results for the sample separators (and the treated separators are clearly increasing in terms of scavenged acid.

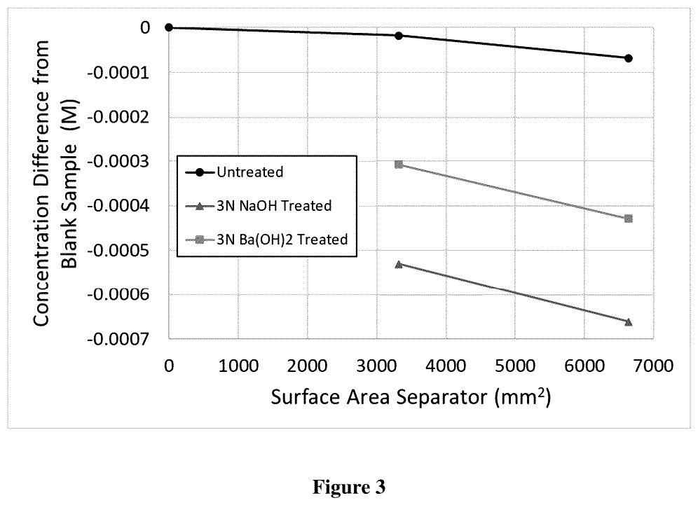

FIG. 3 provides a graph utilizing further data from the measurements and the equation above in relation to the concentration difference from the blank (untreated sample) to the caustic-treated separators. Again, a clear trend shows the benefits of the disclosed separator examples, although, it is evident, to a degree, that an untreated separator may exhibit a slight capability of acid scavenging on its own (but to a much lower level than for the disclosed base-treated separators).

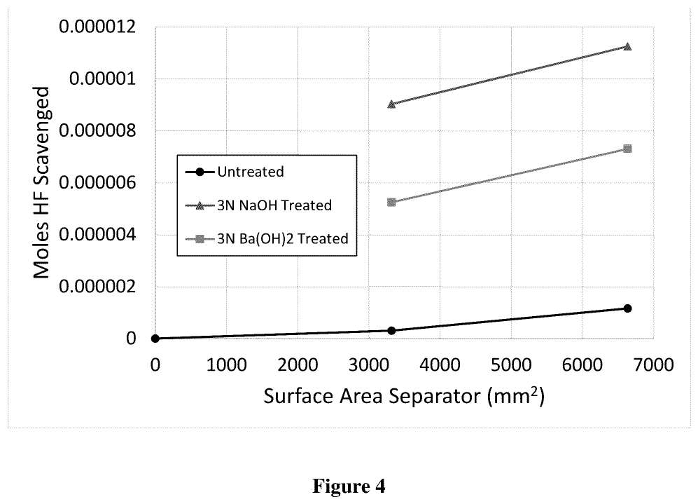

FIG. 4 shows a graphical representation of actual moles HF scavenged in relation to the surface area of the separator (treated and untreated). Again, as expected in relation to the acid scavenging measurements above, such scavenged HF mole results show the basic-treated separators of this disclosure exceed, by far, any untreated separator scavenging capabilities. Additionally, it appears that the sodium hydroxide treatments accorded increased scavenging levels compared with the barium hydroxide treatment separators.

To develop this graph, it was assumed, since the dummy electrolyte was only dosed with HF (in known quantities and concentrations), that:

$$[ {H}^{+} ] = [ HF ]$$

Using the total amount of dummy electrolyte and water to convert to moles:

$$[ HF ] * 0.017 [ L ] = moles of HF$$

And, additionally, such HF scavenging capability on a weight basis of the subject separator may be calculated utilizing following equation to convert to mass of separator:

$$SA separator [ {mm}^{2} ] * {10}^{- 6} [ \frac{{m}^{2}}{{mm}^{2}} ] * 15. [ \frac{g}{{m}^{2}} ] = mass separator [ g ]$$

Since the molar mass for HF is known:

$$mole HF * 20.01 [ \frac{g}{mole} ] = mass HF [ g ]$$

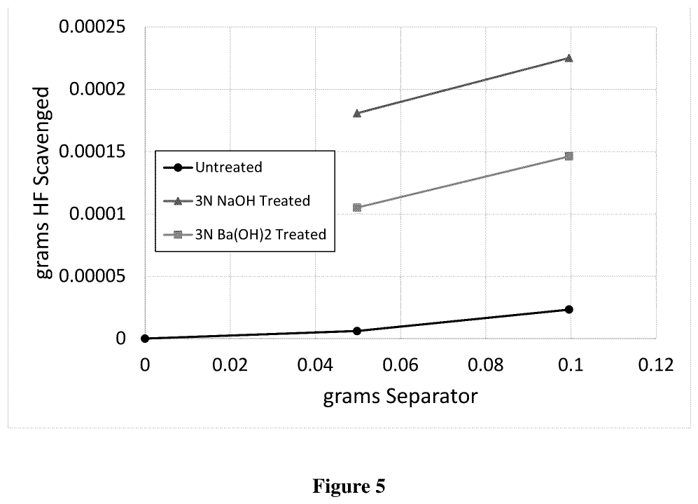

the ability to generate the results in FIG. 5, wherein a relation between grams of treated separator and grams of HF scavenged is provided, is possible.

In summary, as surface area (or mass) of separator is increased, there is an increase in the amount of HF scavenging capability. The amount of HF scavenged by the untreated separator is significantly less than that of the base-treated separators, which provides evidence that the base-treatment of separator is impacting the scavenging capability. Both base treatments were conducted by dosing the separator (with appropriate drainage) of an excess of 3N base. That is, the (—OH) groups present in each base were equivalent. There are two possible explanations of why the NaOH treated separator outperformed the Ba(OH)². The first is that Barium exhibits a higher charge that creates a difficulty in releasing its second (—OH) group. The second is that the smaller NaOH group had an easier time permeating the separator. Both the Ba and Na groups displayed a similar slope, which indicates a higher scavenging rate with increased separator amount, over the untreated separator. This indicates a uniform functionalization of the separator surface.

Thus, HF scavenging capability is enhanced when the separator is treated with a base. Normalized separator treatments (3N vs 3M solutions) provide confidence that the same number of (—OH) groups were introduced into the separator environment(s). As it is, the disclosed base-treated separators exhibit HF scavenging capabilities and capacities that heretofore have been unexplored within the rechargeable energy storage device area. Such improvements utilizing such treated separator components thus allow for safer and better performing batteries, as well.

Having described the disclosure in detail it is obvious that one skilled in the art will be able to make variations and modifications thereto without departing from the scope of the present disclosure. Accordingly, the scope of the present disclosure should be determined only by the claims appended hereto.

That which is claimed:

1. A battery separator for a lithium-ion battery cell, said battery separator exhibiting counterions on the surface thereof, wherein said counterions are selected from the group consisting of ions contributed by bases having pK_{b} levels of at most 6.0, and wherein said battery separator exhibits hydrofluoric acid scavenging properties.

2. The battery separator of claim 1 wherein said counterions are selected from sodium ions, magnesium ions, potassium ions, barium ions, and calcium ions.

3. A battery comprising the battery separator of claim 1, wherein said battery separator is positioned between a cathode and an anode therein.

4. A battery comprising the battery separator of claim 2, wherein said battery separator is positioned between a cathode and an anode therein.

5. The battery separator of claim 1, wherein said counterions are applied during or subsequent to manufacture of said battery separator.

6. The battery separator of claim 3, wherein said counterions are sodium ions.

7. The battery separator of claim 1, wherein said counterions are selected from the group consisting of ions contributed by bases having pK_{b} levels of at most 4.0.
